(19) United States
(12) Patent Application Publication
(10) Pub. No.: US 2009/0100918 A1
(43) Pub. Date: Apr. 23, 2009

(54) Systems and Methods for Testing Gas Turbine Engines

(75) Inventor: Miguel A. Cires, Jupiter, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNITED TECHNOLOGIES CORP., Hartford, CT (US)

(21) Appl. No.: 11/861,468

(22) Filed: Sep. 26, 2007

(51) Int. Cl. G01M 15/14; G01M 15/02

(52) U.S. Cl. 73/112.01; 73/116.03

(57) ABSTRACT

Systems and methods for testing gas turbine engines are provided. In this regard, a representative system for testing a gas turbine engine having an inlet includes an inflatable seal having an interior chamber operative to receive pressurized gas such that the seal inflates to engage circumferentially about the exterior of an inlet of a gas turbine engine.

### BACKGROUND

1. Technical Field

The disclosure generally relates to gas turbine engines.

2. Description of the Related Art

Ground testing of gas turbine engines oftentimes is accomplished by mounting such an engine to a test stand. Testing of an engine in such a manner can be performed for a variety of reasons and can include operating the engine at numerous power settings and configurations. By way of example, thrust reversers of an engine can be tested. Unfortunately, use of thrust reversers during testing can increase the risk of the engine ingesting debris.

### SUMMARY

Systems and methods for testing gas turbine engines are provided. In this regard, an exemplary embodiment of a system for testing a gas turbine engine having an inlet comprises an inflatable seal having an interior chamber operative to receive pressurized gas such that the seal inflates to engage circumferentially about the exterior of an inlet of a gas turbine engine.

Another exemplary embodiment of a system for testing a gas turbine engine having an inlet comprises: a length of flexible tubing extending between a first free end and a second free end thereof, the tubing defining an interior chamber, in an installed configuration the first free end being positioned adjacent to the second free end, the interior chamber being operative to receive pressurized gas such that, in the installed configuration, the tubing inflates to form a circumferential seal about the inlet of the gas turbine engine.

An exemplary embodiment of a method for testing a gas turbine engine having an inlet comprises: positioning an inflatable seal circumferentially about the exterior of an inlet of a gas turbine engine; and inflating the inflatable seal.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a system for testing the gas turbine engine that is positioned about an inlet of a representative gas turbine engine.

FIG. 2 is a schematic diagram depicting a portion of the system of FIG. 1, showing detail of the seal keeper and inflatable seal.

FIG. 3 is a schematic diagram depicting another exemplary embodiment of a system for testing a gas turbine engine.

### DETAILED DESCRIPTION

Systems and methods for testing gas turbine engines are provided, several exemplary embodiments of which will be described in detail. In this regard, embodiments of such a system incorporate inflatable seals that are configured to be positioned about inlets of gas turbine engines that are to be tested. Once inflated (i.e., at least partially filled with gas), the inflatable seal seals a gap formed between the exterior of the inlet and another component, such as a duct used to provide air to the inlet. In operation, the inflatable seal tends to conform to inlets of various sizes and shapes.

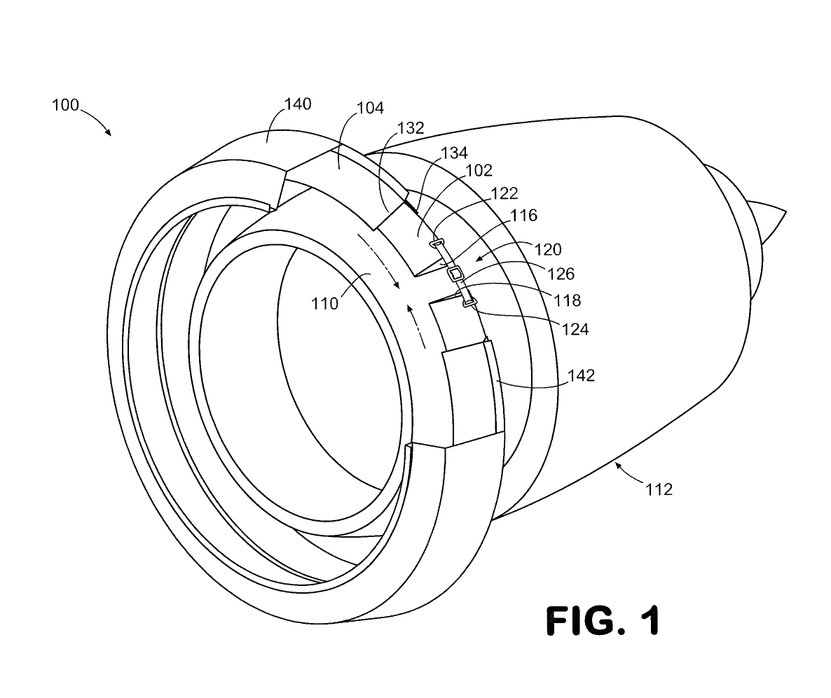

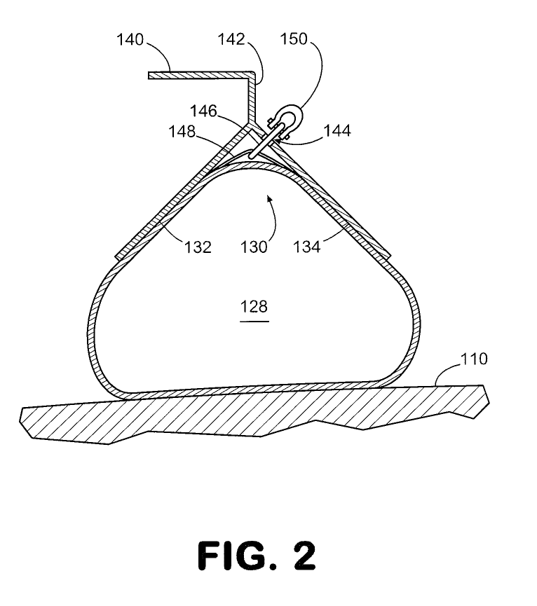

Referring now in more detail to the drawings, FIG. 1 is a schematic diagram illustrating an exemplary embodiment of a system for testing a gas turbine engine. As shown in FIG. 1, system 100 includes an inflatable seal 102 and a seal keeper 104, which assists in positioning the seal. In this embodiment, seal 102 is configured as a length of flexible tubing that defines an interior chamber (128 of FIG. 2), which functions as an air bladder. Although only one contiguous chamber is used in the embodiment of FIG. 1, various other numbers and configurations of chambers can be used.

In FIG. 1, seal 102 is depicted in an installed configuration about the inlet 110 of a gas turbine engine 112. It should be noted that although the gas turbine engine of FIG. 1 is configured as a turbofan, the concepts described herein are not limited to use with turbofan gas turbine engines.

Free ends 116, 118 of the seal are configured to be drawn toward each other so that the seal can be positioned circumferentially about the inlet of the gas turbine engine. In the installed configuration, the free ends of this embodiment are urged toward each other as depicted by the opposing arrows. This is accomplished by use of a positioning assembly 120 that includes anchors 122, 124 (e.g., D-rings) and a corresponding connector 126 (e.g., an adjustable cargo strap). In operation, the connector attaches to and draws the anchors together, thereby positioning the free ends adjacent to each other. Notably, depending upon the size of the seal and size of the engine about which the seal is positioned, the free ends could contact each other in the installed configuration. Also, although only one positioning assembly is depicted, other embodiments could use additional sets of anchors and connectors. Additionally or alternatively, although positioning assembly 120 is located at the radially outermost portion of the seal, various other locations could be used, such as on the leading and/or trailing edges of the seal.

Various materials can be used for forming the inflatable seal. By way of example, fiber reinforced neoprene can be used. Notably, the selection of materials can influence the pressure of gas used to inflate the seal. For instance, when fiber-reinforced neoprene is the material used, a representative pressure range of between approximately 0.3 psig (2.07 kPa) and approximately 5.0 psig (34.49 kPa), preferably between approximately 0.5 psig (3.45 kPa) and approximately 1.0 psig (6.89 kPa) can be used. In some embodiments, the gas used to inflate the seal is air, whereas various other gases, such as nitrogen, can be used in other embodiments.

As shown in FIGS. 1 and 2, axial positioning of the seal about the inlet is generally maintained by seal keeper 104 (only a portion of which is depicted in FIG. 1 for clarity). Notably, seal keeper 104 is an annular component, the radially innermost portion 130 of which is configured to contact the exterior of the inflatable seal. In this embodiment, portion 130 is configured as an annular trough formed by extensions 132 and 134. The extensions define an included angle of between approximately 80° and approximately 100°, preferably between approximately 85° and approximately 95°. The extensions are attached to the supporting structure of a duct 140 by an annular flange 142. It should be noted that a portion of the duct and flange to which the seal keeper is attached is removed in FIG. 1 for clarity.

As shown in FIG. 2, the seal is attached to extension 134 to assist in positioning of the seal and to prevent ingestion of the seal into an engine during use. Depicted in FIG. 2 is one of many different attachment configurations that can be used. In this regard, extension 134 includes a series of slots (e.g., slot 144) through which corresponding anchors (e.g., anchor 146) are inserted. In this embodiment, the anchors are D-rings that are secured to the material forming the air bladder of the seal by flexible patches (e.g., patch 148). The distal ends of the anchors are attached to locking members (e.g., locking member 150) that form interference fits with the corresponding slots, thus preventing withdrawal of the anchors from the slots. In FIG. 2, locking member 150 is a shackle although other configurations can be used in other embodiments.

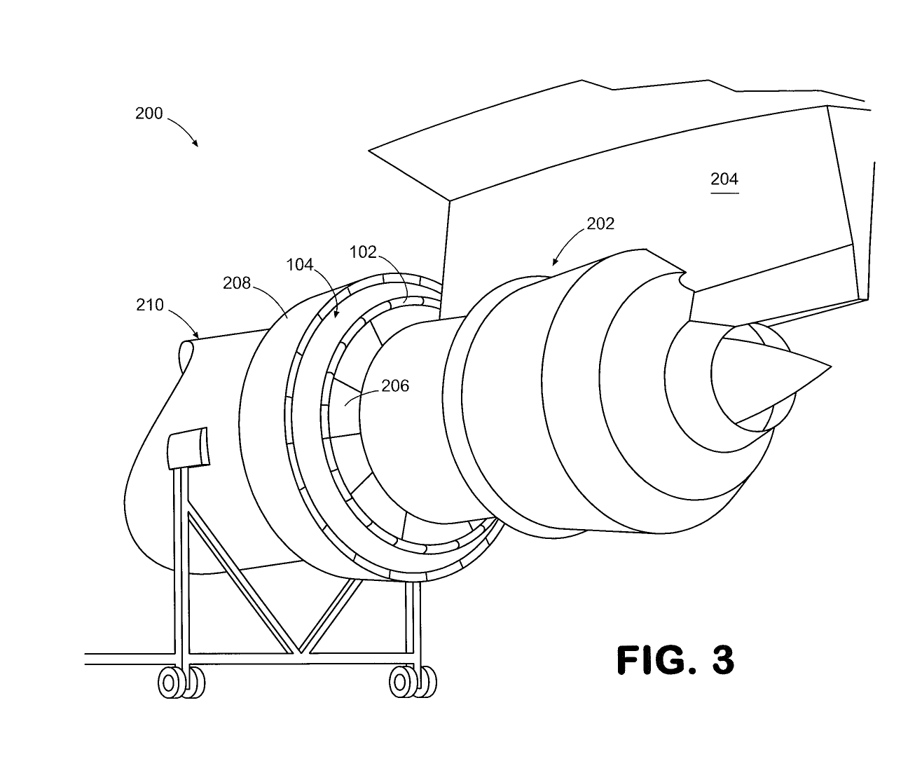

FIG. 3 schematically depicts another embodiment of a system for testing a gas turbine engine. As shown in FIG. 3, system 200 includes inflatable seal 102 and seal keeper 104 from FIGS. 1 and 2, with a gas turbine engine 202 mounted to a test stand 204. Specifically, seal 102 is depicted forming a seal between an inlet 206 of engine 202 and an outlet 208 of an inlet duct system 210. Many different inlet duct systems can be used for different purposes. As an example, inlet duct system 210 is configured as an anti-reingestion duct for preventing debris that has been disturbed by use of thrust reversers of the engine, for example, from being ingested into the engine. This is accomplished by the duct providing intake air to the engine from farther upstream from the engine than would otherwise be provided by inlet 206.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A system for testing a gas turbine engine having an inlet, said system comprising:
an inflatable seal having an interior chamber operative to receive pressurized gas such that the seal inflates to engage circumferentially about the exterior of an inlet of a gas turbine engine.

2. The system of claim 1, wherein:
the system further comprises an inlet duct operative to direct inlet air to the inlet of the gas turbine engine; and
the inflatable seal is operative to form a seal between the inlet duct and the inlet of the gas turbine engine.

3. The system of claim 2, wherein the inlet duct is an anti-reingestion duct operative to prevent ingestion of debris into the inlet of the gas turbine engine during operation, by the engine, of a thrust reverser.

4. The system of claim 2, further comprising a test stand operative to support the gas turbine engine during testing.

5. The system of claim 1, wherein the inflatable seal further comprises an attachment assembly operative to secure the inflatable seal to an inlet duct, the inlet duct being operative to direct inlet air to the inlet of the gas turbine engine.

6. The system of claim 1, wherein the attachment assembly comprises anchors located at spaced intervals about the inflatable seal.

7. The system of claim 1, wherein the inflatable seal has first a first free end and a second free end.

8. The system of claim 7, wherein, in an installed configuration, the first free end is positioned adjacent to the second free end.

9. The system of claim 7, wherein the inflatable seal further comprises a positioning assembly operative to maintain the first free end in position adjacent to the second free end in an installed configuration.

10. The system of claim 9, wherein, in the installed configuration, the first free end contacts the second free end.

11. The system of claim 9, wherein the positioning assembly comprises a first anchor attached to the first free end, a second anchor attached to the second free end, and a strap, the strap being operative to extend between the first and second anchors.

12. The system of claim 11, wherein the first anchor comprises a D-ring.

13. The system of claim 1, wherein the gas turbine engine is a turbofan.

14. A system for testing a gas turbine engine having an inlet, said system comprising:
a length of flexible tubing extending between a first free end and a second free end thereof, the tubing defining an interior chamber, in an installed configuration the first free end being positioned adjacent to the second free end, the interior chamber being operative to receive pressurized gas such that, in the installed configuration, the tubing inflates to form a circumferential seal about the inlet of the gas turbine engine.

15. The system of claim 14, wherein the tubing is formed of fiber reinforced neoprene.

16. A method for testing a gas turbine engine having an inlet, said method comprising:
positioning an inflatable seal circumferentially about the exterior of an inlet of a gas turbine engine; and
inflating the inflatable seal.

17. The method of claim 16, wherein:
the method further comprises positioning a duct upstream of the inlet; and
the inflatable seal forms a seal between the duct and the inlet.

18. The method of claim 17, further comprising attaching the inflatable seal to the duct such that deflation of the inflatable seal does not result in the inflatable seal detaching from the duct.

19. The method of claim 17, further comprising testing the gas turbine engine while the inflatable seal is inflated.

20. The method of claim 19, further comprising supporting the gas turbine engine during the testing.
